(19) United States
(12) Patent Application Publication
(10) Pub. No.: US 2018/0370453 A1
(43) Pub. Date: Dec. 27, 2018

(54) MOTOR VEHICLE HAVING A VARIABLE PAYLOAD VOLUME

(71) Applicant: Ford Global Technologies, LLC, Dearborn, MI (US)

(72) Inventors: Torsten Gerhardt, London (GB); Igor Fischbein, Cologne (DE); James Neugebauer, Chelmsford (GB); Bruce Southey, Farnham (GB)

(21) Appl. No.: 15/942,820

(22) Filed: Apr. 2, 2018

(30) Foreign Application Priority Data
Jun. 27, 2017 (DE) 102017210828.2

(51) Int. Cl. B60R 9/06; B60R 7/02; B62D 31/00

(52) U.S. Cl. CPC B60R 9/065; B62D 31/003; B60R 7/02

(57) ABSTRACT

An exemplary motor vehicle assembly includes a vehicle with trunk having a trunk opening, a container, and at least one trunk lid. The container, while coupled to the vehicle, is pivotable back and forth between a first position where the container is inside the trunk, and a second position where the container is outside the trunk. The at least one trunk lid is moveable from an open position to a closed position that closes the trunk opening when the container is in the second position.

### CROSS-REFERENCE TO RELATED APPLICATIONS

This application claims priority to German Patent Application No. 102017210828.2, which was filed on 27 Jun. 2017 and is incorporated herein by reference in its entirety.

### TECHNICAL FIELD

The disclosure relates to a motor vehicle with a variable payload volume. More particularly, this disclosure relates to a container that can be selectively received within a trunk of the motor vehicle.

### BACKGROUND

Motor vehicles with a hatchback, for example, can include a trunk at the rear with a trunk opening which is closable by way of a pivotably arranged trunk lid. In small cars, the available trunk is relatively small in size. If more loaded goods are to be transported in a motor vehicle than the trunk can accommodate, it is known to arrange additional means for holding the loaded goods, for example a luggage carrier, at the rear of the motor vehicle or on the vehicle roof.

Such measures are disclosed, for example, in US Patent Application No. 2010/0206929, U.S. Pat. No. 5,544,799, EP Patent Application No. 2368765A1 and GB Patent Application No. 2512096A.

Also, FR Patent Application No. 2845053A1 discloses using a lower lid element of a trunk lid, which is situated in an open position and is divided horizontally into two, as an extension to the trunk floor and arranging a circumferential side wall on the lower lid element in order to provide an object placed or set onto the lower lid element with lateral support.

Further, EP Patent Application No. 0556472A2 and DE Patent Application No. 3025145A1 each propose a motor vehicle where the rear area is modifiable for transporting larger objects. US Patent Application 2008/0238122 relates to a trunk lid arrangement of a motor vehicle, in particular of a passenger vehicle, having a trunk expansion element, which is mounted on a trunk lid on the inside of the vehicle, surrounds a cavity and is connected or connectable in a gas-tight and water-tight manner to a trunk of the motor vehicle for the extension thereof and is clampable between the trunk lid and a rear carrier which is mounted at the rear of the vehicle.

### SUMMARY

The disclosure relates to a motor vehicle with a variable payload volume.

In an exemplary non-limiting embodiment, a motor vehicle includes at least one mechanism, which is mounted in the region of the trunk and is connectable in a hinged manner to the container. By way of the mechanism, the container is can be moved between a first position, in which the container is arranged completely inside the trunk, and a second position, in which the container is arranged completely outside the trunk. The trunk lid, a rear portion of the motor vehicle, or both are configured in such a manner that the container, with the trunk lid situated in the closed position, is able to be held in the second position by the mechanism.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a schematic and perspective view of a motor vehicle with a container situated inside the trunk according to an exemplary aspect of the present disclosure.

FIG. 2 illustrates a schematic and perspective view of the motor vehicle of FIG. 1 with the container situated outside the trunk.

### DETAILED DESCRIPTION

This disclosure relates generally to a motor vehicle having at least one rear trunk with a rear trunk opening. at least one pivotably arranged trunk lid which closes the trunk opening in a closed position and opens the trunk opening at least in part in an open position, and at least one container for receiving loaded goods which is dimensioned in such a manner that, with the trunk lid situated in the open position, it is insertable into the trunk and is removable from said trunk via the trunk opening.

The payload volume of the motor vehicle can be by the container being arranged completely inside or outside of the rear trunk. If the container is arranged completely inside the trunk, the payload volume can essentially correspond to the loading volume of the trunk. If the container is arranged completely outside the trunk, the payload volume is formed by the loading volume of the trunk and the loading volume of the container such that the payload volume, with the container situated in the second position, is greater than with the container situated inside the trunk.

In an exemplary embodiment, the container is in a first position when inside the trunk, and a second position when outside the trunk. The movement of the container between the first position and the second position, or the given handling of the container, can be handled by a mechanism. That is, the container, can be forcibly guided by the mechanism back and forth between the first and second position. A user of the motor vehicle does not consequently have to be ensured that the container is positioned in a certain manner relative to the trunk in the first position and the second position. Instead, the container, which is connected to the mechanism, is transferred in a substantially automated and targeted manner into the first position or second position in the given manner as a result of the forcible guiding when the container is moved.

The mechanism can be mounted on the body of the motor vehicle so as to be movable in the region of the trunk. The mechanism can be connected in a substantially permanent manner to the container. As an alternative to this, the mechanism can be connected, only when needed, in a non-destructively detachable manner to the container when the container is to be transferred from the first position into the second position. As a result, it is possible to detach the container from the mechanism if necessary in order, for example, to be able to operate the motor vehicle without the container. Dispensing with the mechanism is in line some exemplary aspects of the present disclosure.

The container, when detached, can be transferred manually into the second position and can be held in a positionally secure manner in said position by safety elements. Conceivable here are hooks which are arranged on the container and are connected to suitable counter fastenings in the trunk cover plate. The container can also be fastened to the bumper. The container, when detached, can be stored in the vehicle or in another place outside the vehicle, for example in the garage or a similar intermediate storage place.

The mechanism can comprise at least one damping unit or the like, by way of which the movement of the container, for example prior to reaching the second position, is damped or slowed, which is in particular advantageous when the container is arranged lower in the second position than in the first position.

To transfer the container from the first position into the second position, the trunk lid is pivoted into the open position such that the trunk is accessible via the trunk opening. If the container is not connected permanently to the mechanism, the mechanism is then connected to the container. Next, the container can then be grasped by a user, for example by means of at least one handle which is arranged thereon in the form of a grip or the like. The user can then exert a tensile force onto the container such that the container is moved out of the first position. The container can instead, or additionally, be forcibly moved by the mechanism. In particular, the container could be raised first of all by a certain amount by the mechanism such that the container, during the further movement of the container in the direction of the second position, is able to be guided over a loading edge, which delimits the trunk opening at the bottom, without touching the loading edge. The user can then move the container further in the direction of the second position until the container has reached the second position. As a result of the hinged or pivotable connection between the mechanism and the container, the container maintains a spatial alignment during the movement. That is, the container is not tilted during the movement. Once the container is situated in the second position, the trunk lid can be transferred into the closed position again. The trunk lid, the rear portion of the vehicle that connects to the mechanism, or both can be configured such that at least one component of the mechanism can extend between the trunk lid and the rear portion when the trunk lid is in the closed position This makes it possible for the trunk lid to move to the closed position when the container is in the second position and held by the mechanism.

The container can have a top that can be open or closed. In the latter case, the container can comprise at least one closable opening, by means of which loaded goods are insertable into the container or removable from said container. The container is preferably produced from lightweight materials. For example, the container can be produced at least in part from a light metal, a light metal alloy, a plastics material or a fiber composite material. The container can comprise a dimensionally stable support structure that is provided with dimensionally stable or flexible wall elements.

The motor vehicle can include, for example, a hatchback or fastback. The motor vehicle can be, for example, a passenger vehicle, in particular a small car. The trunk lid can be connected in a hinged manner to the body of the motor vehicle on a side remote from the ground and can be pivotable as one unit. As an alternative to this, the trunk lid can be divided into two in a horizontal manner and can comprise an upper lid element, which is connected in a hinged manner to the body on the side of the trunk lid remote from the ground, and a lower element which is connected to the body on the side of the trunk lid close to the ground. Naturally, the trunk lid can also be realized as a single or multi-winged door. When configured as a multi-winged trunk lid, the trunk lid is divided vertically into two in an exemplary embodiment and can include case lid elements that are connected to the body at the side. A single-winged trunk lid can also be attached at the side or at the bottom or top. In this respect, the term trunk lid is to be understood to apply to a structure that can close or open an opening of the motor vehicle.

In an exemplary embodiment, the mechanism includes at least one pivot arm, which is mounted in the region of the trunk so as to be pivotable about a pivot axis that is aligned parallel to a vehicle transverse axis. The at least one pivot arm is connectable in a hinged manner to the container in such a manner that the container, which is connected to the pivot arm, maintains its spatial alignment when the pivot arm pivots. The pivot arm can be mounted on the body of the motor vehicle so as to be pivotable in the region of the trunk. The mechanism preferably includes two corresponding pivot arms each connected to the container in a hinged manner laterally on oppositely situated sides.

At least one recess, through which the pivot arm runs with the container situated in the second position, can be included on the trunk lid and/or on an edge portion of the trunk opening. As a result, the container, with the trunk lid situated in the closed position, can be held in the second position by means of the mechanism. At least one sealing element, which, with the trunk lid in the closed position and the container in the second position, surrounds the pivot arm in a sealing manner, can be arranged on the recess. As a result, the trunk is sealed in relation to the surrounding area of the motor vehicle in the region of the recess. The pivot arm, with the container situated in the second position, can consequently be clamped between the trunk lid, which is situated in the closed position, and the edge portion of the trunk opening in order to secure the position of the pivot arm taken up in this case. The number of recesses preferably corresponds to the number of pivot arms of the mechanism.

A further advantageous configuration provides that the mechanism comprises at least one safety mechanism, by way of which at least one position of the pivot arm, with the container situated in the second position, is temporarily securable relative to the trunk and/or at least one position of the container, which is situated in the second position, is temporarily securable relative to the pivot arm. If the safety mechanism is set up for temporarily securing the position of the pivot arm with the container situated in the second position, the safety mechanism can prevent the pivot arm being moved during a journey of the motor vehicle or as a result of vibrations and vehicle movements occurring in this case relative to the trunk and the rear portion of the motor vehicle, as a result of which damage is prevented to the trunk lid and/or to the rear portion. Such damage could be caused by contact between the trunk lid or the rear portion and the pivot arm portion as a result of mechanical load. If the safety mechanism is set up for temporarily securing the position of the container, which is situated in the second position, relative to the pivot arm, the safety mechanism can prevent the container being moved during a journey of the motor vehicle, which could impair the driving dynamics of the motor vehicle.

According to a further embodiment, the container is realized in a water-tight and/or air-tight manner. As a result, the loaded goods which are situated in the container or in the interior of the container can be protected from environmental influences, when the container is situated in the second position.

According to a further embodiment, the container is realized in a dimensionally stable manner at least in part. The container can be provided, for example, totally from dimensionally stable components. As an alternative to this, the container can comprise, for example, a dimensionally stable support structure to which flexible wall elements are fastened. The flexible wall elements can be formed, for example, by an impregnated and/or laminated woven fabric.

According to another exemplary embodiment, the container can be at least partially transparent. As a result, the interior of the container can be looked into without opening the container. In addition, the container can be realized in a transparent manner in such a manner that a user looking into a rearview mirror, which is arranged in the vehicle interior, is able to see by through the container, which is situated in the first position, and consequently through a rear windshield, which is arranged on the trunk lid. This improves the driving safety of the motor vehicle.

In another exemplary embodiment, the container is shaped in a way that corresponds to a shaping of the trunk such that the container, when completely in the trunk, takes up at least half the trunk. The more precisely the shaping of the container is adapted to the shaping of the trunk, the more loading volume of the trunk is available inside the container. The container can in some examples take up at least 70%, in other examples at least 80%, and in other examples at least 90% of the trunk. Since the loading volume of the trunk with the container situated in the first position is largely available as a result of said adaptation of the shaping of the container to the shaping of the trunk, the container can be taken along with the motor vehicle without the payload capacity of the motor vehicle being impaired. In this connection, the container can then be permanently connected to the mechanism. It is possible that as a result of the adapted shaping of the container to the shaping of the trunk, registrations and/or lights of the vehicle could be covered. In this regard, the container can include a registration holder for receiving a registration and/or signaling devices, which correspondingly comprises vehicle lighting on two sides (rear light, indicators, brake light etc.). Safe lighting and registration are further secured in this way. The container then comprises corresponding connections in order to ensure the lighting.

According to another exemplary aspect of the present disclosure, the container can include at least one closable loading/unloading opening. Loaded goods can be inserted into the container or removed from said container via the loading/unloading opening. The loading/unloading opening can be closed by way of a closing element, for example a cover, a flap or the like. To this end, the container can comprise, in addition to the closing element, a closing mechanism, which secures the closed position of the closing element. The container can also comprise two or multiple corresponding loading/unloading openings.

The motor vehicle can, in some examples, include at least one electrically actuatable drive, which is connected to the mechanism in such a manner that the mechanism is actuatable for moving the container between the first position and the second position by way of the drive. As a result, the movement of the container between the first position and the second position can be automated. An activating element can be arranged on the motor vehicle and/or on a vehicle remote control, as a result of the manual actuation of said activating element the drive is activatable in order to actuate the mechanism. The drive can comprise at least one electric motor. In addition, there can be at least one sensor means for detecting the respective state of the mechanism in order to be able to detect by means of electronics whether the container is situated in the first position or in the second position. The electronics can be set up to actuate the drive in dependence on the respectively detected position of the container in order to transfer the container either into the second position or the first position.

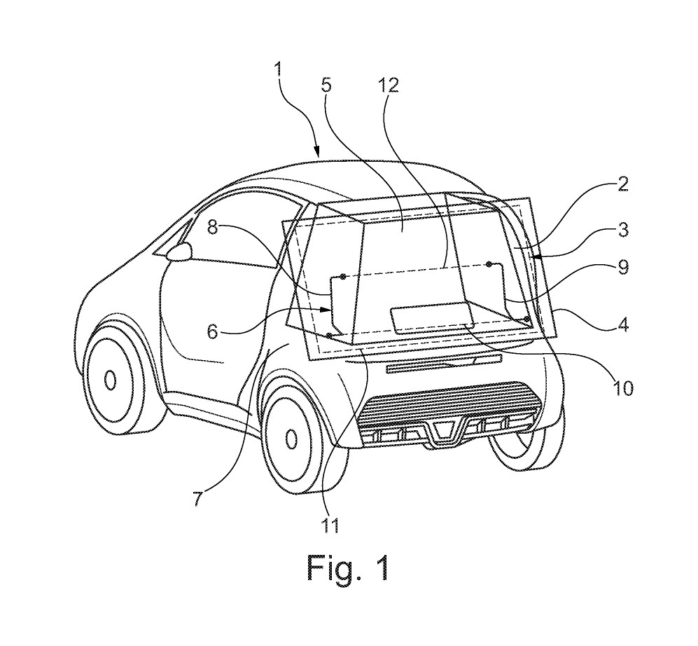

With reference now to FIG. 1, in an exemplary embodiment of the present disclosure a motor vehicle 1 includes a rear trunk 2 having a rear trunk opening 3, and a pivotably arranged trunk lid 4. The pivotably arranged trunk lid 4 is moveable back and forth between a closed position, which closes the trunk opening 3, and at least one open position, which opens the trunk opening. The trunk lid 4 is shown in the closed position in FIG. 1.

The motor vehicle 1 includes a container 5 for receiving loaded goods. The container 5 is dimensioned in such a manner that, with the trunk lid 4 situated in the open position, the container 5 is insertable into the trunk 2 and is removable from said trunk 2 via the rear trunk opening 3.

In the exemplary, non-limiting embodiment of FIG. 1, the container 5 is arranged completely inside the trunk 2, and the container 5 has truncated-pyramid-like shape.

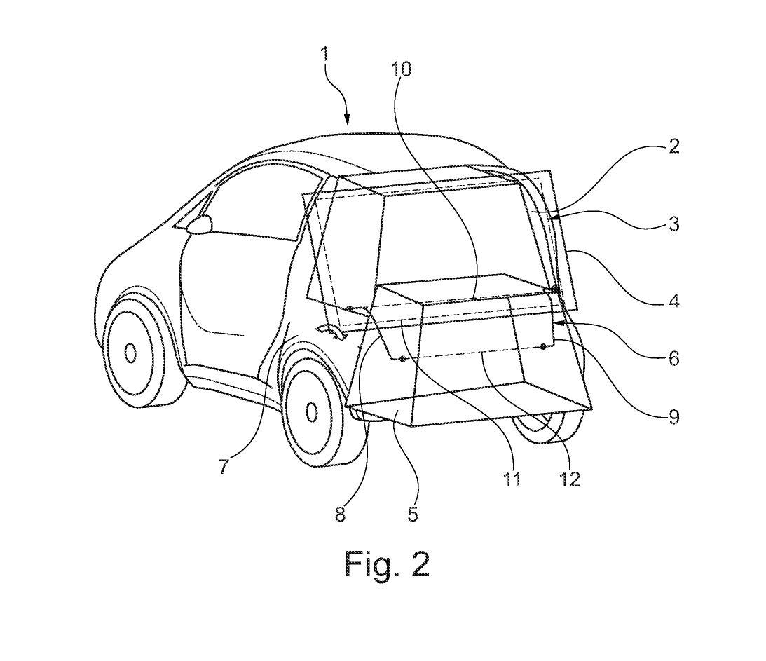

The motor vehicle 1 additionally includes a mechanism 6 which is mounted in the area of the trunk and is connected in a hinged manner to the container 5. The mechanism 6 is configured to move the container 5 between a first position shown in FIG. 1 and a second position shown in FIG. 2. In the exemplary embodiment, the container 5 is arranged completely inside the trunk 2 when in the first position, and arranged completely outside the trunk 2 when in the second position.

The trunk lid 4, a rear portion 7 of the motor vehicle 1, or both, can connect to the mechanism 6. The trunk lid 4, the rear portion 7, or both are configured such the container 5, with the trunk lid 4 situated in the closed position, can be held in the second position by the mechanism 6.

In an exemplary embodiment, the mechanism 6 includes two laterally arranged pivot arms 8 and 9, which are each mounted in the region of the trunk 2. The pivot arms 8 and 9 are mounted to be pivotable about a pivot axis 10, which is aligned parallel to a vehicle transverse axis. The pivot arms 8 and 9 each connect in a hinged manner to the container 5 in such a manner that the container 5 maintains a spatial alignment shown as the pivot arms 8 and 9 pivot. To this end, the container 5 is connected to the pivot arms 8 and 9 so as to be pivotable about an axis 12.

The trunk lid 4, a ground-side edge portion 11 of the loading opening 3, or both, can include a recess for each pivot arm 8 or 9. When the container 5 is situated in the second position, the respective pivot arm 8 or 9 can fit within the recess.

The mechanism 6 can comprise at least one safety mechanism. The safety mechanism can secure the pivot arms 8 and 9 in at least one position relative to the trunk 2 with the container 5 situated in the second position. The safety mechanism can instead, or additionally, temporarily secure the pivot arms 8 and 9 relative to the container 5 when the container 5 is situated in the second position.

The container 5 can be realized in a water-tight and/or air-tight manner. As an alternative to this or in addition to it, the container 5 can be, at least in part, realized in a dimensionally stable manner. As an alternative to this or in addition to it, the container 5 can be realized, at least in part, in a transparent manner. As an alternative to this or in addition to it, the container 5 can comprise a shaping, which is adapted to the shaping of the trunk 2, such that the container 5, which is arranged completely in the trunk 2, takes up at least half the trunk 2. As an alternative to this or in addition to it, the container 5 can comprise at least one closable loading/unloading opening.

The motor vehicle 1 can comprise at least one electrically actuatable drive that is connected to the mechanism 6 in such a manner that the mechanism 6 is actuatable for moving the container 5 between the first position and the second position by way of the drive.

FIG. 2 shows a schematic and perspective representation of the motor vehicle 1 shown in FIG. 1 with the container 5 situated entirely outside the trunk 2. The container 5 is therefore situated in the second position. To transfer the container 5 out of the first position shown in FIG. 1 into the second position shown in FIG. 2, the trunk lid 4 is pivoted into the open position. The container 5 is then moved manually or by means of the drive out of the first position into the second position. During the movement of the container 5, the container 5 is forcibly guided by the mechanism 6. Once the container 5 has reached the second position shown, the trunk lid 4 is pivoted back to the closed position.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A motor vehicle assembly, comprising:
at least one rear trunk having a rear trunk opening;
at least one pivotably arranged trunk lid moveable between a closed position that closes the trunk opening and at least one open position that opens the trunk opening;
at least one container for receiving loaded goods, the container dimensioned such that, with the trunk lid situated in the at least one open position, the container is insertable into the trunk and is removable from said trunk via the trunk opening; and
at least one mechanism mounted in the region of the trunk, the mechanism hingeably connected to the container, the mechanism configured to move the container between a first position where the container is arranged completely inside the trunk, and a second position where the container is arranged completely outside the trunk,
the trunk lid, a rear portion of the motor vehicle, or both coupled to the at least one mechanism and configured such that the container, with the trunk lid situated in the closed position, is held in the second position by the mechanism.

2. The assembly of claim 1, wherein the mechanism comprises at least one pivot arm mounted in the region of the trunk and configured to pivot about a pivot axis that is parallel to a vehicle transverse axis, the pivot arm hingeably connected to the container such that the container, which is connected to the pivot arm, maintains a spatial alignment when the pivot arm pivots.

3. The assembly of claim 1, wherein the trunk lid and/or on an edge portion of the trunk opening provide a least one recess, the pivot arm configured to fit within the recess when the container (5) is in the second position.

4. The assembly of claim 1, wherein the mechanism includes at least one safety mechanism that is configured to secure a position of the pivot arms relative to the trunk, a position of the pivot arms relative to the container, or both when the container is in the second position.

5. The assembly of claim 1, wherein the container is water-tight, air-tight, or both.

6. The assembly of claim 1, wherein the container is at least partially dimensionally stable.

7. The assembly of claim 1, wherein the container is at least partially transparent.

8. The assembly of claim 1, wherein the container has a shaping corresponding to a shaping of the trunk such that the container, which is arranged completely in the trunk, takes up at least half the trunk.

9. The assembly of claim 1, wherein the container comprises at least one closable loading and unloading opening.

10. The assembly of claim 1, further comprising, at least one electrically actuatable drive connected to the mechanism, the at least one electrically actuatable drive configured to actuate the mechanism to move the container back and forth between the first and the second position.

11. A motor vehicle assembly, comprising:
a vehicle with trunk having a trunk opening;
a container that, while coupled to the vehicle, is pivotable back and forth between a first position where the container is inside the trunk, and a second position where the container is outside the trunk,
at least one trunk lid moveable from an open position to a closed position that closes the trunk opening when the container is in the second position.

12. The assembly of claim 11, further comprising at least one mechanism pivotably coupling the container to the vehicle.

13. The assembly of claim 12, wherein at least one component of the at least one mechanism extends between the at least one trunk lid and a portion of the vehicle when the at least one trunk lid is in the closed position.

14. The assembly of claim 13, wherein the portion is a rear portion of the vehicle.

15. The assembly of claim 12, wherein the at least one mechanism includes a first pivot arm on a first lateral side of the container and a second pivot arm on an opposite, second lateral side of the container.

16. The assembly of claim 15, wherein the first and second pivot arms are configured to pivot about a pivot axis that is parallel to a vehicle transverse axis, the first and second pivot arms each hingeably connected to the container such that the container, which is connected to the first and second pivot arms, maintains a spatial alignment as the container is moved back and forth between the first and second positions.

17. The assembly of claim 11, wherein the container has a shaping corresponding to a shaping of the trunk such that the container, which is arranged completely in the trunk, takes up at least half the trunk.

18. The assembly of claim 11, wherein the container is at least partially transparent.
